(19) United States
(12) Patent Application Publication
(10) Pub. No.: US 2025/0155948 A1
(43) Pub. Date: May 15, 2025

(54) ELECTRONIC DEVICE AND METHOD FOR CONTROLLING ELECTRONIC DEVICE

(71) Applicant: SAMSUNG ELECTRONICS CO., LTD., Suwon-si (KR)

(72) Inventors: Hyunseok KIM, Suwon-si (KR); Hyuntaek NA, Suwon-si (KR)

(73) Assignee: SAMSUNG ELECTRONICS CO., LTD., Suwon-si (KR)

(21) Appl. No.: 19/020,074

(22) Filed: Jan. 14, 2025

Related U.S. Application Data
(63) Continuation of application No. PCT/KR2023/007841, filed on Jun. 8, 2023.

(30) Foreign Application Priority Data
Jul. 27, 2022 (KR) 10-2022-0093435

(51) Int. Cl. G06F 1/3206; G06F 1/3296

(52) U.S. Cl. CPC G06F 1/3206; G06F 1/3296

(57) ABSTRACT

Disclosed is an electronic device including an infrared sensor, a power supply part which supplies power to the infrared sensor. The electronic device controls the power supply part to supply a first power voltage signal with an on-duty ratio of less than 1 to the infrared sensor, and control, based on a trigger signal being received through the infrared sensor while the infrared sensor is operating based on the first power voltage signal, the power supply part to supply a second power voltage signal with an on-duty ratio of 1 to the infrared sensor.

### CROSS-REFERENCE TO RELATED APPLICATIONS

This application is a bypass continuation application of International Application No. PCT/KR2023/007841 designating the United States, filed on Jun. 8, 2023, in the Korean Intellectual Property Receiving Office and claiming priority to Korean Patent Application No. 10-2022-0093435, filed on Jul. 27, 2022, in the Korean Intellectual Property Office, the disclosures of which are incorporated by reference herein in their entireties.

### BACKGROUND

### 1. Field

The disclosure relates to an electronic device and a method for controlling the electronic device, and more particularly to an electronic device that receives and processes an infrared signal and a method for controlling the electronic device.

### 2. Description of Related Art

With developments in electronic technology, various electronic devices that coincide with the needs of consumers are being developed. Specifically, recently, various electronic devices that can control an operation using remote controllers are being developed.

Communication methods that use infrared rays between remote controllers and electronic devices are being widely used. Specifically, a remote controller may include an infrared transmitter and transmit a control signal according to a user operation to the outside in an infrared form, and the electronic device may include an infrared sensor and perform a corresponding operation after converting and interpreting the received infrared signal to an electric signal.

### SUMMARY

According to an aspect of the disclosure, there is provided an electronic device including an infrared sensor; a power supply part which supplies power to the infrared sensor; memory storing instructions; and at least one processor, wherein the instructions, when executed by the at least one processor, cause the electronic device to: control the power supply part to supply a first power voltage signal with an on-duty ratio of less than 1 to the infrared sensor; and control, based on a trigger signal being received through the infrared sensor while the infrared sensor is operating based on the first power voltage signal, the power supply part to supply a second power voltage signal with an on-duty ratio of 1 to the infrared sensor.

The power supply part may include a switch with one end connected to the second power voltage signal, and the other end connected to the infrared sensor.

The instructions, when executed by the at least one processor, cause the electronic device to apply a pulse width modulation (PWM) control signal with an on-duty ratio of the first power voltage signal to the switch for the first power voltage signal to be supplied to the infrared sensor.

The instructions, when executed by the at least one processor, cause the electronic device to apply, based on the trigger signal being received through the infrared sensor while the infrared sensor is operating based on the first power voltage signal, a pulse width modulation (PWM) control signal with an on-duty ratio of the second power voltage signal to the switch for the second power voltage signal to be supplied to the infrared sensor.

The trigger signal may include two or more consecutive pulse signals with a shorter period than the first power voltage signal.

The infrared sensor may be configured to receive an infrared signal from an infrared remote controller corresponding to a user operation for the infrared remote controller, and wherein the infrared signal received from the infrared remote controller may include the signal corresponding to the user operation and the trigger signal added in front of the signal corresponding to the user operation.

The instructions, when executed by the at least one processor, cause the electronic device to control, based on an infrared signal not being received for greater than or equal to a predetermined time from the infrared remote controller while the second power voltage signal is supplied to the infrared sensor, the power supply part to supply the first power voltage signal to the infrared sensor.

The infrared remote controller may include a plurality of keys, and wherein the trigger signal may be added in front of a signal corresponding to a pressed key, regardless of a type of the pressed key from among the plurality of keys.

The instructions, when executed by the at least one processor, cause the electronic device to control, while the electronic device is operating in a standby mode or an operation mode, the power supply part to supply the first power voltage signal to the infrared sensor, and control, based on the trigger signal being received through the infrared sensor while the infrared sensor is operating based on the first power voltage signal, the power supply part to supply the second power voltage signal to the infrared sensor, and wherein in the standby mode, power may be supplied only to a portion of configurations that may include the infrared sensor from among a plurality of configurations included in the electronic device, and in the operation mode, power may be supplied to the portion of configurations and remaining configurations.

According to an aspect of the disclosure, there is provided a method for controlling an electronic device including an infrared sensor, the method including: supplying a first power voltage signal with an on-duty ratio of less than 1 to the infrared sensor; and supplying, based on a trigger signal being received through the infrared sensor while the infrared sensor is operating based on the first power voltage signal, a second power voltage signal with an on-duty ratio of 1 to the infrared sensor.

The electronic device may include a switch with one end connected to the second power voltage signal, and the other end connected to the infrared sensor. 1

The supplying the first power voltage signal may include applying a pulse width modulation (PWM) control signal with an on-duty ratio of the first power voltage signal to the switch and supplying the first power voltage signal to the infrared sensor.

The supplying the second power voltage signal may include applying, based on the trigger signal being received through the infrared sensor while the infrared sensor is operating based on the first power voltage signal, a pulse width modulation (PWM) control signal with an on-duty ratio of the second power voltage signal to the switch and supplying the second power voltage signal to the infrared sensor.

The trigger signal may include two or more consecutive pulse signals with a shorter period than the first power voltage signal.

According to an aspect of the disclosure, there is provided a non-transitory computer-readable medium storing computer instructions that, when executed by a processor of an electronic device which includes an infrared sensor, cause the electronic device to perform operations including: supplying a first power voltage signal with an on-duty ratio of less than 1 to the infrared sensor; and supplying, based on a trigger signal being received through the infrared sensor while the infrared sensor is operating based on the first power voltage signal, a second power voltage signal with an on-duty ratio of 1 to the infrared sensor.

### BRIEF DESCRIPTION OF THE DRAWINGS

The above and other aspects and/or features of one or more embodiments of the disclosure will be more apparent from the following detailed description, taken in conjunction with the accompanying drawings, in which:

FIG. 1 is a diagram illustrating an infrared communication system according to an embodiment of the disclosure;

FIG. 2 is a block diagram illustrating an electronic device according to an embodiment of the disclosure;

FIG. 3 is a diagram illustrating power A supply of an electronic device according to an embodiment of the disclosure;

FIG. 4 is a diagram illustrating power A voltage signal supplied to an infrared sensor according to an embodiment of the disclosure;

FIG. 5 is an example diagram illustrating an infrared signal being received through an infrared sensor according to an embodiment of the disclosure;

FIG. 6 is a diagram illustrating a recognition operation of a trigger signal according to an embodiment of the disclosure; and

FIG. 7 is a flowchart illustrating a control method of an electronic device according to an embodiment of the disclosure.

### DETAILED DESCRIPTION

In describing the disclosure, in case it is determined that the detailed description of related known technologies may unnecessarily confuse the gist of the disclosure, the detailed description thereof will be omitted. In addition, redundant descriptions of same configurations will be omitted.

Suffixes such as “portion” for elements used in the description below have been added or used combined therewith considering its easiness in preparing the disclosure, and do not have meaning or role that distinguishes one another on its own.

Terms used in the disclosure have been merely used to describe a specific embodiment, and is not intended to limit the disclosure. A singular expression includes a plural expression, unless otherwise specified.

In the disclosure, it is to be understood that the terms such as ‘have’ or ‘include’ are used herein to designate a presence of a characteristic, number, step, operation, element, component, or a combination thereof, and not to preclude a presence or a possibility of adding one or more of other characteristics, numbers, steps, operations, elements, components or a combination thereof.

Expressions such as “1st”, “2nd”, “first” or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element). Conversely, when the certain element (e.g., the first element) is indicated as “directly coupled with/to” or “directly connected to” another element (e.g., the second element), it may be understood as other element (e.g., the third element) not being present between the certain element and the another element.

The terms used in the embodiments of the disclosure may be interpreted to have meanings generally understood to one of ordinary skill in the art unless otherwise defined.

Various embodiments of the disclosure will be described in detail below with reference to the accompanied drawings.

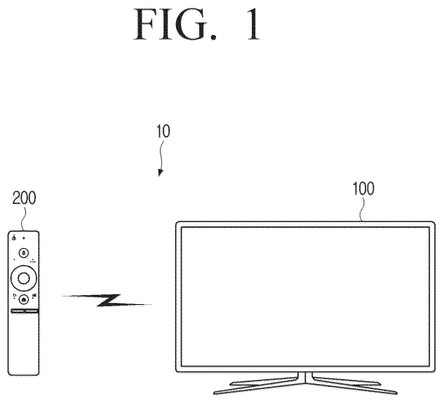

FIG. 1 is a diagram illustrating an infrared communication system according to an embodiment of the disclosure. An infrared communication system 10 according to FIG. 1 may include an infrared transmitting device 200 and an electronic device 100.

The infrared transmitting device 200 may transmit various signals, information, and data in an infrared signal form. Specifically, the infrared transmitting device 200 may transmit a control signal for controlling an operation of the electronic device 100 in the infrared signal form. To this end, the infrared transmitting device 200 may include an infrared transmission module.

For example, the infrared transmitting device 200 may be an infrared remote controller, but is not limited thereto, and any device may be the infrared transmitting device 200 so long as the device can transmit a control signal for controlling an operation of the electronic device 100 in the infrared signal form.

The electronic device 100 may receive an infrared signal transmitted by the infrared transmitting device 200, and perform an operation corresponding to the received infrared signal. To this end, the electronic device 100 may include an infrared sensor.

For example, the electronic device 100 may be implemented in various devices such as, for example, and without limitation, a display device such as a television (TV) or a monitor, a broadcast receiving device such as a set top box, an air conditioner, an audio system, a projector, a washer, a refrigerator, and the like. However, the embodiment is not limited thereto, and may be the electronic device 100 according to an embodiment of the disclosure so long as the device is any device which includes the infrared sensor and an operation of the device can be controlled through the infrared signal transmitted from the infrared transmitting device 200.

In the infrared communication system 10 described above, because the electronic device 100 is configured to detect the infrared signal transmitted by the infrared transmitting device 200 and operate accordingly thereto, the infrared sensor is configured to maintain a turned-on state at all times.

For example, as shown in FIG. 1, assuming that the infrared transmitting device 200 is the infrared remote controller, and the electronic device 100 is the TV, the infrared sensor is to be maintained in an operating state at all times because the TV receives various control signals (e.g., channel operations, volume operations, turn-on operations, etc.) transmitted from the infrared remote controller, and operates accordingly thereto.

To this end, power is to be supplied to the infrared sensor at all times, but this leads to a continuous consumption of power.

According to an embodiment of the disclosure, the electronic device 100 may control power voltage which is supplied to the infrared sensor through pulse width modulation (PWM). For example, the electronic device 100 may control for the infrared sensor to operate by power A voltage signal with an on-duty that is less than 1 when there is no user operation for the infrared transmitting device 200. Accordingly, power consumed from the infrared sensor may be reduced.

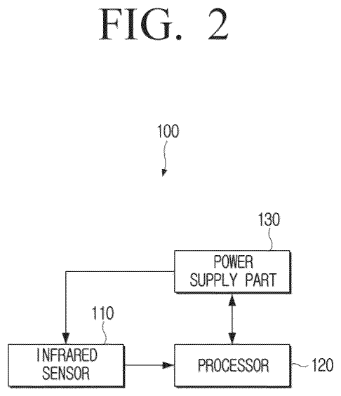

FIG. 2 is a block diagram illustrating an electronic device according to an embodiment of the disclosure. Referring to FIG. 2, the electronic device 100 may include an infrared sensor 110, a processor 120, and power A supply part 130.

The infrared sensor 110 may receive infrared signals, and convert and output the received infrared signals into electric signals. Specifically, the infrared sensor 110 may receive, based on a control signal for controlling an operation of the electronic device 100 being received from the infrared transmitting device 200 in the infrared signal form, the same and convert into an electric signal, and provide the converted electric signal to the processor 120. Meanwhile, there may be no limitation to an implementation form of the infrared sensor 110.

The power supply part 130 may supply power to each configuration of the electronic device 100. Specifically, the power supply part 130 may supply a first power voltage signal with an on-duty ratio of less than 1 or a second power voltage signal with an on-duty ratio of 1 to the infrared sensor 110 by receiving control of the processor 120. To this end, the power supply part 130 may include a switch mode power supply (SMPS), a DC/DC converter, a switch, and the like, but is not limited thereto.

Here, the on-duty ratio may mean a ratio of time during which a pulse is in an on state for one period in a pulse signal having a period. Accordingly, the second power voltage signal with the on-duty ratio of 1 may become a constant voltage signal in which an on voltage is maintained according to a flow of time.

The processor 120 may control an overall operation of the electronic device 100. Specifically, the processor 120 may control power voltage supplied to the infrared sensor 110 through PWM. Here, controlling the power voltage supplied to the infrared sensor 110 through PWM may mean controlling an on-duty ratio of the power voltage supplied to the infrared sensor 110.

For example, the processor 120 may control the power supply part 130 to supply the first power voltage signal in which the on-duty ratio is less than 1 to the infrared sensor 110. At this time, the on-duty ratio of the first power voltage signal may be, for example, 0.5 (i.e., 50%), but is not limited thereto.

Specifically, the processor 120 may control the power supply part 130 to supply the first power voltage signal to the infrared sensor 110 by applying a PWM control signal having the on-duty ratio of the first power voltage signal to the power supply part 130.

When the first power voltage signal is applied, the infrared sensor 110 may be repeatedly turned-on and turned-off according to the on-duty ratio of the first power voltage signal. Accordingly, when the infrared sensor 110 is driven by the first power voltage signal, power consumed from the infrared sensor 110 may be reduced than when driven by the second power voltage signal with the on-duty ratio of 1.

Meanwhile, the processor 120 may control, based on a trigger signal being received through the infrared sensor 110 while the infrared sensor 110 operates based on the first power voltage signal, the power supply part 130 to supply the second power voltage signal with the on-duty ratio of 1 (i.e., 100%) to the infrared sensor 110.

Specifically, the processor 120 may receive the trigger signal through the infrared sensor 110 while the infrared sensor 110 operates based on the first power voltage signal.

For example, when a user operation is input in the infrared transmitting device 200 to control an operation of the electronic device 100, the infrared transmitting device 200 may generate a signal corresponding to the user operation and output in the infrared signal form. At this time, according to an embodiment of the disclosure, the infrared transmitting device 200 may output an infrared signal by adding the trigger signal in front of the signal corresponding to the user operation.

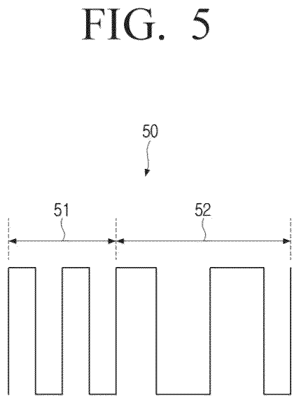

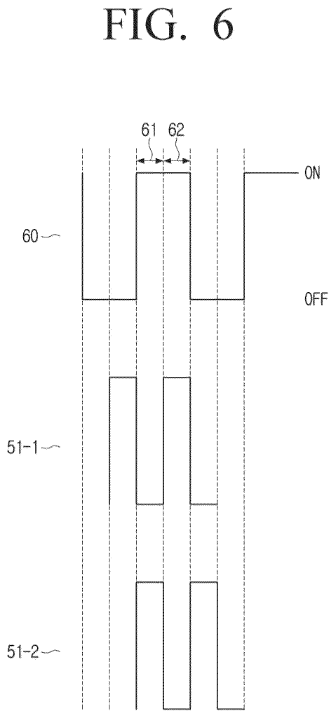

The trigger signal may have a form which can be recognized separately from the signal corresponding to the user operation even when the infrared sensor 110 is operating based on the first power voltage signal with the on-duty ratio of less than 1. For example, the trigger signal may include two or more consecutive pulse signals having a shorter period than the first power voltage signal, but is not limited thereto. A more detailed description on the trigger signal will be described below in FIG. 5 to FIG. 6.

The processor 120 may apply the PWM control signal having the on-duty ratio (i.e., 1) of the second power voltage signal to the power supply part 130 based on receiving the trigger signal. Accordingly, a power voltage signal supplied to the infrared sensor 110 by the power supply part 130 may be changed from the first power voltage signal to the second power voltage signal.

When the power voltage signal supplied to the infrared sensor 110 is changed to the second power voltage signal, the infrared sensor 110 may maintain the turned-on state. Accordingly, the infrared sensor 110 may convert the signal corresponding to the user operation included in the received infrared sensor to an electric signal and provide to the processor 120, and the processor 120 may control the electronic device 100 to perform an operation corresponding to the user operation.

Meanwhile, according to an embodiment of the disclosure, the processor may control, based on an infrared signal not being received for greater than or equal to a predetermined time from the infrared transmitting device 200 while the second power voltage signal is being provided to the infrared sensor 110, the power supply part 130 to supply the first power voltage signal to the infrared sensor 110.

That is, the infrared signal not being received for greater than or equal to the predetermined time may be determined as a user no longer having any intention to control an operation of the electronic device 100 using the infrared transmitting device 200, and in this case, the processor 120 may reduce, by changing the power voltage signal for driving the infrared sensor 110 back to the first power voltage signal, power consumption of the infrared sensor 110.

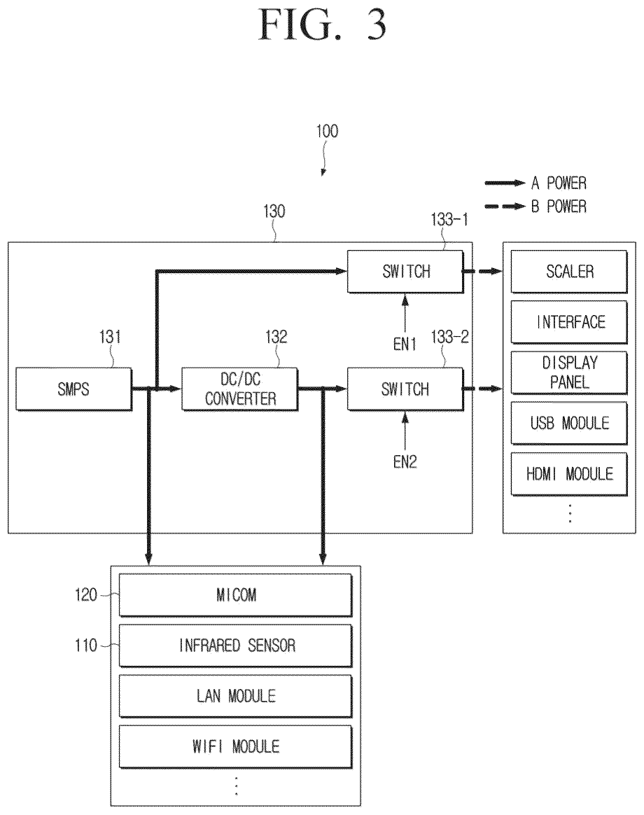

FIG. 3 is a diagram illustrating power A supply of an electronic device according to an embodiment of the disclosure. Referring to FIG. 3, the power supply part 130 may include a switch mode power supply (SMPS) 131, a DC/DC converter 132, and switches 133-1 and 133-2.

The SMPS 131 may be power A supply device which uses switching circuitry, and may receive alternating current power and convert and output to direct current power. For example, the SMPS 131 may receive 220[V] or 110[V] alternating current power and convert and output to 13[V] direct current power. However, a magnitude of voltage is not limited thereto. The direct current power output from the SMPS 131 may be appropriately supplied to each configuration of the electronic device 100 that requires power.

The DC/DC converter 132 may be a device that converts direct current power to direct current power, and may receive direct current power and convert and output to direct current power of different magnitudes. For example, the DC/DC converter 132 may convert and output the 13[V] direct current power output from the SMPS 131 to 5[V] or 3.3[V] direct current power. However, the magnitude of voltage is not limited thereto. Because a magnitude of power voltage necessary in various configurations of the electronic device 100 may vary for every configuration, necessary power may be appropriately supplied to each configuration of the electronic device 100 by converting the voltage output from the SMPS 131 using the DC/DC converter 132.

The switches 133-1 and 133-2 may be turned-on according to enable signals EN1 and EN2 and supply direct current power output from the SMPS 131 or the DC/DC converter 132 to each configuration of the electronic device 100. Various configurations that perform several functions may be included in the electronic device 100, but supplying power to all configurations at all times may lead to unnecessary consumption of power. Accordingly, by having power supplied to a relevant configuration only when an operation is necessary, unnecessary power consumption may be prevented. Accordingly, the switches 133-1 and 133-2 may be turned-on through the enable signals EN1 and EN2 only when an operation of the relevant configuration is necessary and supply power to the relevant configuration. At this time, the switches may be implemented as a semiconductor switch such as, for example, and without limitation, a field effect transistor (FET), an insulated gate bipolar transistor (IGBT), or the like, but is not limited thereto.

Referring to FIG. 3, power A which is supplied at all times so long as alternating current power is input to the SMPS 131, and power B which is supplied only when the switches 133-1 and 133-2 are turned-on through the enable signals EN1 and EN2 are shown marked separately as a solid line arrow and a dotted line arrow. At this time, because power A is power that is supplied at all times unless a power cable of the electronic device 100 is separated from a power outlet, power A may be referred to as constant power, and because power B is power that is supplied only when an operation is necessary, power B may be referred to as operation power.

Meanwhile, the electronic device 100 may include two or more operation modes including a standby mode and an operation mode. At this time, in the standby mode, power is supplied only to a portion of the configurations from among a plurality of configurations included in the electronic device 100, and in the operation mode, power is supplied to remaining configurations in addition to the portion of the configurations.

Referring to FIG. 3, in the standby mode, power may be supplied only to configurations (e.g., a Micom 120, the infrared sensor 110, a local area network (LAN) module, a WiFi module, etc.) that operate by power A, and power may not be supplied to configurations (e.g., a scaler, an interface, a display, a universal serial bus (USB) module, a high definition multimedia interface (HDMI) module, etc.) that operate by power B. Meanwhile, in the operation mode, power may be supplied to both the configurations that operate by power A and the configurations that operate by power B. In FIG. 3, configurations that can be included in a smart TV have been provided as examples, but the embodiment is not limited to the example showing the configurations that operate by power A and the configurations that operate by power B.

The Micom 120 may be a portion driven by power A from among function blocks of the processor, and the processor 120 described above in FIG. 2 may mean the Micom 120 shown in FIG. 3. The enable signals EN1 and EN2 for applying power B may be provided from the Micom 120. Because the infrared sensor 110 also has to receive the control signal transmitted from the infrared transmitting device 200, the infrared sensor 110 is also driven by power A. In addition to the above, communication modules such as a LAN module or a WiFi module may also be driven by power A to receive the signal transmitted from the outside.

The scaler may be a portion associated with an image data driving from among the function blocks of the processor, and because there is no need for a screen to be displayed in the standby mode, the scaler may be driven by power B together with a display panel. The interface may be a portion associated with an interface driving from among the function blocks of the processor, and because the above is driven only when an external device is connected through the corresponding interface, the interface may be driven by power B together with a USB module or a HDMI module.

Meanwhile, referring to FIG. 3, power A being applied in the infrared sensor 110 is shown. At this time, according to an embodiment of the disclosure, the processor 120 (or Micom 120) may use a separate PWM control signal different from the enable signals EN1 and EN2 for supplying power B and control power supplied by the power supply part 130 to the infrared sensor 110 as described above in FIG. 2.

In addition, according to an embodiment of the disclosure, the processor 120 (or Micom 120) may control power supplied by the power supply part 130 to the infrared sensor 110 as described above in FIG. 2, regardless of a mode of the electronic device 100 (i.e., when the electronic device 100 operates in the standby mode or when the electronic device 100 operates in the operation mode).

Alternatively, according to an embodiment, power supplied by the power supply part 130 to the infrared sensor 110 may be controlled as described above in FIG. 2 only when the electronic device 100 operates in the operation mode.

Alternatively, according to an embodiment, power supplied by the power supply part 130 to the infrared sensor 110 may be controlled as described above in FIG. 2 only when the electronic device 100 operates in the standby mode.

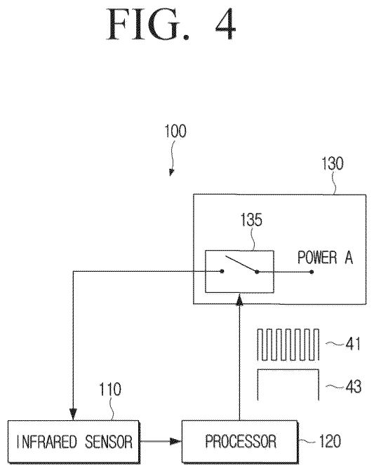

Meanwhile, power A or power B may be a constant voltage signal. Accordingly, if power A is supplied to the infrared sensor 110 as is, power A that is supplied to the infrared sensor 110 may be the above-described second power voltage signal. The power voltage signal supplied to the infrared sensor will be described in greater detail below with reference to FIG. 4.

FIG. 4 is a diagram illustrating power A voltage signal supplied to an infrared sensor according to an embodiment of the disclosure.

Referring to FIG. 4, the power supply part 130 may include a switch 135 with one end connected to power A and the other end connected to the infrared sensor. Accordingly, a waveform of the power voltage signal supplied to the infrared sensor 110 according to a turning-on or turning-off of the switch 135 may vary. At this time, the switch may be implemented with a semiconductor switch such as, for example, and without limitation a FET, a IGBT, and the like, but is not limited thereto.

According to an embodiment of the disclosure, the processor 120 may apply a PWM control signal 41 with an on-duty ratio such as a first power voltage to the switch 135 for the first power voltage signal to be supplied to the infrared sensor 110.

For example, the processor 120 may have the first power voltage signal with an on-duty ratio of 0.5 supplied to the infrared sensor 110 by applying the PWM control signal 41 with the on-duty ratio of 0.5 to the switch 135.

In addition, according to an embodiment of the disclosure, the processor 120 may apply, based on the trigger signal being received through the infrared sensor 110 while the infrared sensor 110 is operating based on the first power voltage, a PWM control signal 43 with an on-duty ratio such as a second power voltage to the switch 135 for the second power voltage signal to be supplied to the infrared sensor 110.

For example, the processor 120 may supply, based on the trigger signal being received, power A which is a constant voltage signal to the infrared sensor 110 as is by applying the PWM control signal 43 with an on-duty ratio of 1 to the switch 135.

FIG. 5 is an example diagram illustrating an infrared signal being received through an infrared sensor according to an embodiment of the disclosure. Referring to FIG. 5, an infrared signal 50 may include a trigger signal 51 and a signal corresponding to a user operation 52.

For example, based on the infrared transmitting device 200 being the infrared remote controller, if the user presses one key (e.g., a power-on key, a channel-up key, a number key, etc.) from among a plurality of keys provided in the infrared remote controller, the infrared remote controller may add the trigger signal 51 in front of a signal corresponding to a pressed key 52, regardless of a type of the pressed key, and output the infrared signal 50.

In FIG. 5, the trigger signal 51 including two consecutive pulse signals with a shorter period than the first power voltage signal has been provided as an example, but a number or period of pulse signals included in the trigger signal 51 is not limited thereto. According to an embodiment of the disclosure, the number, period, and on-duty ratio of the pulse signal included in the trigger signal 51 and the on-duty ratio of the first power voltage signal may be determined by calculation or experimentation with respect to a trigger signal recognition rate in the electronic device 100.

When the infrared signal 50 is received through the infrared sensor 110 which is operating based on the first power voltage signal, the processor 120 may detect the trigger signal 51, and change the power supplied to the infrared sensor 110 to the second power voltage signal. The signal corresponding to the user operation 52 may be received and processed while the infrared sensor 110 is being driven by the second power voltage signal.

Meanwhile, if the infrared signal 50 is received while the infrared sensor 110 is operating based on the second power voltage signal, the processor 120 may ignore the trigger signal 51, and control the electronic device 100 to perform a corresponding operation by processing only the signal corresponding to the user operation 52.

In FIG. 5, a user operation for the infrared transmitting device 200 being an operation of pressing a key has been provided as an example, but the embodiment is not limited thereto. For example, even when there is a motion input or a voice input, the infrared transmitting device 200 may generate a signal corresponding to the input motion or voice, add the trigger signal in front thereof, and output the infrared signal.

FIG. 6 is a diagram illustrating a recognition operation of a trigger signal according to an embodiment of the disclosure. Reference number 60 in FIG. 6 represents an example of the first power voltage signal supplied to the infrared sensor 110, and reference numerals 51-1 and 51-2 show trigger signals. In FIG. 6, for convenience of description, a first power voltage signal 60 and on-duty ratios of the trigger signals 51-1 and 51-2 all being same as 0.5, and a period of two pulse signals included in the trigger signals 51-1 and 51-2 being half of a period of the first power voltage signal 60 have been provided as an example, but the embodiment is not limited thereto.

According to an embodiment of the disclosure, the processor 120 may determine that the trigger signal is received based on detecting any one pulse signal from among the pulse signals included in the trigger signal.

For example, while the infrared sensor 110 is operating by the a first power voltage 60, if a trigger signal such as reference numeral 51-1 is received, the infrared sensor 110 may receive a second pulse signal of the trigger signal 51-1 in a time period corresponding to reference numeral 62 and convert to an electric signal. The converted electric signal as described above may be provided to the processor 120, and the processor 120 may determine that the trigger signal has been received based therefrom.

Meanwhile, while the infrared sensor 110 is operating by the first power voltage 60, if a trigger signal such as reference numeral 51-2 is received, the infrared sensor 110 may receive a first pulse signal of the trigger signal 51-2 in a time period corresponding to reference numeral 61 and convert to an electric signal. The converted electric signal as described above may be provided to the processor 120, and the processor 120 may determine that the trigger signal has been received based therefrom.

As described above, even if the infrared sensor 110 is operated by the first power voltage with the on-duty ratio of less than 1, the processor 120 may detect the trigger signal.

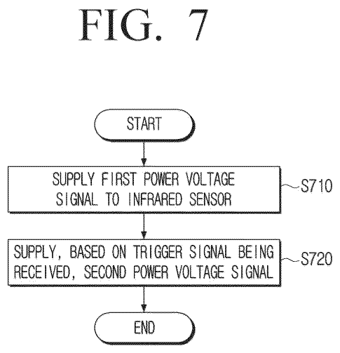

FIG. 7 is a flowchart illustrating a control method of an electronic device according to an embodiment of the disclosure. Referring to FIG. 7, the electronic device 100 may supply the first power voltage signal with the on-duty ratio of less than 1 to the infrared sensor 110 (S710).

Specifically, the electronic device 100 may include the switch 135 with one end connected to the second power voltage signal, and the other end connected to the infrared sensor. The electronic device 100 may apply the PWM control signal with the on-duty ratio of the first power voltage signal to the switch 135 and supply the first power voltage signal to the infrared sensor 110.

Meanwhile, the electronic device 100 may supply, based on the trigger signal being received through the infrared sensor 110 while the infrared sensor 110 is operating based on the first power voltage signal, the second power voltage signal with the on-duty ratio of 1 to the infrared sensor 110 (S720).

Specifically, the electronic device 100 may apply, based on the trigger signal being received through the infrared sensor 110 while the infrared sensor 110 is operating based on the first power voltage signal, the PWM control signal having the on-duty ratio of the second power voltage signal to the switch 135 and supply the second power voltage signal to the infrared sensor 110.

At this time, the trigger signal may include two or more consecutive pulse signals with a shorter period than the first power voltage signal.

Meanwhile, according to an embodiment of the disclosure, the infrared sensor may receive an infrared signal from the infrared remote controller corresponding to the user operation for the infrared remote controller, and the infrared signal received from the infrared remote controller may include the signal corresponding to the user operation and the trigger signal added in front of the signal corresponding to the user operation.

In addition, the electronic device 100 may supply, based on an infrared signal not being received for greater than or equal to a predetermined time from the infrared remote controller while the second power voltage signal is supplied to the infrared sensor 110, the first power voltage signal to the infrared sensor 110.

In addition, the infrared remote controller may include the plurality of keys, and the trigger signal may be added in front of the signal corresponding to the pressed key, regardless of the type of the pressed key from among the plurality of keys.

In addition, according to an embodiment of the disclosure, the electronic device 100 may perform operations of steps S710 and S720 described above while the electronic device 100 is operating in the standby mode or the operation mode. At this time, the standby mode may be a mode in which power is supplied to only a portion of configurations that include the infrared sensor 110 from among the plurality of configurations included in the electronic device 100, and the operation mode may be a mode in which power is supplied to the portion of configurations and the remaining configurations.

According to various embodiments of the disclosure as described above, power consumption consumed in the infrared sensor 110 may be reduced. Accordingly, the power consumption of the electronic device 100 may be reduced.

Meanwhile, the various embodiments of the disclosure may be implemented with software including instructions stored in a machine-readable storage media (e.g., computer). The machine may call a stored instruction from the storage medium, and as a device operable according to the called instruction, may include the electronic device 100 according to the above-mentioned embodiments.

Based on the instruction being executed by a processor, the processor may directly or using other elements under the control of the processor perform a function corresponding to the instruction. The instruction may include a code generated by a compiler or executed by an interpreter. A machine-readable storage medium may be provided in a form of a non-transitory storage medium. Herein, ‘non-transitory’ merely means that the storage medium is tangible and does not include a signal, and the term does not differentiate data being semi-permanently stored or being temporarily stored in the storage medium.

According to an embodiment, a method according to the various embodiments described in the disclosure may be provided included a computer program product. The computer program product may be exchanged between a seller and a purchaser as a commodity. The computer program product may be distributed in a form of the machine-readable storage medium (e.g., a compact disc read only memory (CD-ROM)), or distributed online through an application store (e.g., PLAYSTORE™). In the case of online distribution, at least a portion of the computer program product may be stored at least temporarily in the storage medium such as a server of a manufacturer, a server of an application store, or a memory of a relay server, or temporarily generated.

Each of the elements (e.g., a module or a program) according to the various embodiments may be formed as a single entity or a plurality of entities, and a portion of sub-elements from among the above-mentioned sub-elements may be omitted, or other sub-elements may be further included in the various embodiments. Alternatively or additionally, a portion of elements (e.g., modules or programs) may be integrated into one entity to perform the same or similar functions performed by the respective elements prior to integration. Operations performed by a module, a program, or another element, in accordance with the various embodiments, may be executed sequentially, in a parallel, repetitively, or in a heuristic manner, or at least a portion of operations may be executed in a different order, omitted or a different operation may be added.

While the descriptions above merely describe examples of the technical spirit of the disclosure, various changes in form and details may be made by one of ordinary skill in the art to which the disclosure pertains without departing from the spirit and scope of the disclosure. In addition, the one or more embodiments according to the disclosure are intended to be illustrative, not limiting, and it will be understood that the scope of the disclosure is not limited by the one or more embodiments described above. Accordingly, the scope of the disclosure is to be interpreted by what is claimed below, and all technical concepts that fall within an equivalent scope thereof are to be interpreted as included in the scope of the disclosure.

What is claimed is:

1. An electronic device, comprising:
an infrared sensor;
a power supply part which supplies power to the infrared sensor;
memory storing instructions; and
at least one processor,
wherein the instructions, when executed by the at least one processor, cause the electronic device to:
control the power supply part to supply a first power voltage signal with an on-duty ratio of less than 1 to the infrared sensor; and
control, based on a trigger signal being received through the infrared sensor while the infrared sensor is operating based on the first power voltage signal, the power supply part to supply a second power voltage signal with an on-duty ratio of 1 to the infrared sensor.

2. The electronic device of claim 1, wherein the power supply part comprises a switch with one end connected to the second power voltage signal, and the other end connected to the infrared sensor.

3. The electronic device of claim 2, wherein the instructions, when executed by the at least one processor, cause the electronic device to apply a pulse width modulation (PWM) control signal with an on-duty ratio of the first power voltage signal to the switch for the first power voltage signal to be supplied to the infrared sensor.

4. The electronic device of claim 2, wherein the instructions, when executed by the at least one processor, cause the electronic device to apply, based on the trigger signal being received through the infrared sensor while the infrared sensor is operating based on the first power voltage signal, a pulse width modulation (PWM) control signal with an on-duty ratio of the second power voltage signal to the switch for the second power voltage signal to be supplied to the infrared sensor.

5. The electronic device of claim 1, wherein the trigger signal comprises two or more consecutive pulse signals with a shorter period than the first power voltage signal.

6. The electronic device of claim 1, wherein the infrared sensor is configured to receive an infrared signal from an infrared remote controller corresponding to a user operation for the infrared remote controller, and
wherein the infrared signal received from the infrared remote controller comprises the signal corresponding to the user operation and the trigger signal added in front of the signal corresponding to the user operation.

7. The electronic device of claim 6, wherein the instructions, when executed by the at least one processor, cause the electronic device to control, based on an infrared signal not being received for greater than or equal to a predetermined time from the infrared remote controller while the second power voltage signal is supplied to the infrared sensor, the power supply part to supply the first power voltage signal to the infrared sensor.

8. The electronic device of claim 6, wherein the infrared remote controller comprises a plurality of keys, and
wherein the trigger signal is added in front of a signal corresponding to a pressed key, regardless of a type of the pressed key from among the plurality of keys.

9. The electronic device of claim 1, wherein the instructions, when executed by the at least one processor, cause the electronic device to control, while the electronic device is operating in a standby mode or an operation mode, the power supply part to supply the first power voltage signal to the infrared sensor, and control, based on the trigger signal being received through the infrared sensor while the infrared sensor is operating based on the first power voltage signal, the power supply part to supply the second power voltage signal to the infrared sensor, and
wherein in the standby mode, power is supplied only to a portion of configurations that comprise the infrared sensor from among a plurality of configurations comprised in the electronic device, and in the operation mode, power is supplied to the portion of configurations and remaining configurations.

10. A method for controlling an electronic device comprising an infrared sensor, the method comprising:
supplying a first power voltage signal with an on-duty ratio of less than 1 to the infrared sensor; and
supplying, based on a trigger signal being received through the infrared sensor while the infrared sensor is operating based on the first power voltage signal, a second power voltage signal with an on-duty ratio of 1 to the infrared sensor.

11. The method of claim 10, wherein the electronic device comprises a switch with one end connected to the second power voltage signal, and the other end connected to the infrared sensor.

12. The method of claim 11, wherein the supplying the first power voltage signal comprises applying a pulse width modulation (PWM) control signal with an on-duty ratio of the first power voltage signal to the switch and supplying the first power voltage signal to the infrared sensor.

13. The method of claim 11, wherein the supplying the second power voltage signal comprises applying, based on the trigger signal being received through the infrared sensor while the infrared sensor is operating based on the first power voltage signal, a pulse width modulation (PWM) control signal with an on-duty ratio of the second power voltage signal to the switch and supplying the second power voltage signal to the infrared sensor.

14. The method of claim 10, wherein the trigger signal comprises two or more consecutive pulse signals with a shorter period than the first power voltage signal.

15. The method of claim 10, wherein the infrared sensor is configured to receive an infrared signal from an infrared remote controller corresponding to a user operation for the infrared remote controller, and
wherein the infrared signal received from the infrared remote controller comprises the signal corresponding to the user operation and the trigger signal added in front of the signal corresponding to the user operation.

16. The method of claim 15, further comprising:
based on an infrared signal not being received for greater than or equal to a predetermined time from the infrared remote controller while the second power voltage signal is supplied to the infrared sensor, supplying the first power voltage signal to the infrared sensor.

17. The method of claim 15,
wherein the infrared remote controller comprises a plurality of keys, and
wherein the trigger signal is added in front of a signal corresponding to a pressed key, regardless of a type of the pressed key from among the plurality of keys.

18. The method of claim 10,
wherein, while the electronic device is operating in a standby mode or an operation mode, the supplying the first power voltage signal and the supplying the second power voltage signal are performed
wherein in the standby mode, power is supplied only to a portion of configurations that comprise the infrared sensor from among a plurality of configurations comprised in the electronic device, and in the operation mode, power is supplied to the portion of configurations and remaining configurations.

19. A non-transitory computer-readable medium storing computer instructions that, when executed by a processor of an electronic device which includes an infrared sensor, cause the electronic device to perform operations comprising:
supplying a first power voltage signal with an on-duty ratio of less than 1 to the infrared sensor, and
supplying, based on a trigger signal being received through the infrared sensor while the infrared sensor is operating based on the first power voltage signal, a second power voltage signal with an on-duty ratio of 1 to the infrared sensor.

20. The non-transitory computer-readable medium of claim 19, wherein the electronic device comprises a switch with one end connected to the second power voltage signal, and the other end connected to the infrared sensor.
